(19) United States
(12) Patent Application Publication
(10) Pub. No.: US 2026/0169805 A1
(43) Pub. Date: Jun. 18, 2026

(54) INTELLIGENT ROUTER FOR DISTRIBUTING REQUESTS TO DIFFERENT GENERATIVE AI INSTANCES

(71) Applicant: Microsoft Technology Licensing, LLC, Redmond, WA (US)

(72) Inventors: Saravanakumar RAJMOHAN, Redmond, WA (US); Rujia WANG, Chicago, IL (US); Chetan BANSAL, Seattle, WA (US); Ankur MALLICK, Bellevue, WA (US); Anjaly PARAYIL, Bengaluru (IN); Victor Jonas RÜHLE, Cambridge (GB); Kunal JAIN, Bengaluru (IN)

(21) Appl. No.: 18/984,927

(22) Filed: Dec. 17, 2024

(30) Foreign Application Priority Data
Aug. 9, 2024 (IN) 202411060276

(51) Int. Cl. G06F 9/50; G06F 40/279; G06F 40/30

(52) U.S. Cl. CPC G06F 9/5027; G06F 40/279; G06F 40/30

(57) ABSTRACT

An intelligent router for generative artificial intelligence (GAI) model instances optimizes request routing to reduce latency. The system predicts output lengths using a trained response-length predictor and assesses the state of multiple GAI instances, including prompt and decode distributions. It estimates the workload mixing impact of routing requests to each instance and determines selection probabilities using a machine-learning routing model. The router either assigns the request to the most suitable instance or delays routing if conditions are suboptimal. This approach improves end-to-end latency, Time-To-First-Token (TTFT), and Time-Between-Tokens (TBT) by considering the distinct characteristics of GAI workload phases.

### PRIORITY CLAIM

This patent application claims the benefit of priority, under 35 U.S.C. Section 119 to Indian Provisional Patent Application No. 202411060276, entitled “Intelligent Scheduler for Large Language Model Requests for Optimal Performance,” filed on Aug. 9, 2024 to Wang, et. al, which is hereby incorporated by reference herein in its entirety.

### TECHNICAL FIELD

Embodiments pertain to improvements in generative artificial intelligence requests. Some embodiments relate to reduction in latency for generative artificial intelligence requests using intelligent routing schemes.

### BACKGROUND

Generative artificial intelligence (GAI) models, particularly large language models (LLMs), have emerged as powerful tools for a wide range of applications including conversational engines, search engines, and code assistants. These models process input requests from users and generate contextually relevant responses. The requests from users range from chat interactions to document summarization and content creation. The widespread adoption of these large models has made GAI inference a dominant workload on modern computing infrastructure, particularly graphics processing units (GPUs).

GAI models such as LLMs process requests using multiple phases, including a prefill phase that processes input tokens in parallel, and a decode phase that generates output tokens sequentially based on the processed input and cached context. This multi-phase processing approach allows GAI models to generate coherent and contextually appropriate responses while managing computational resources efficiently.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram of a GAI model routing system according to some examples of the present disclosure.

FIG. 2 shows a flowchart of a method of intelligently routing a request to one of a plurality of GAI instances according to some examples of the present disclosure.

FIG. 3 shows a system of a network-based GAI inference service according to some examples of the present disclosure.

FIG. 4 illustrates a block diagram of an example machine upon which any one or more of the techniques discussed herein may be performed according to some examples of the present disclosure.

### DETAILED DESCRIPTION

Processing requests by a GAI model may be performed by hardware in cloud environments, where different model instances are hosted by commercial cloud providers or dedicated inference platforms that serve requests from multiple users. Each request is routed by a router to a different model instance for processing and for producing an output.

A model instance refers to a discrete generative artificial intelligence (GAI) model that is capable of handling inference requests and that produces an output. In some examples, each model instance may be a same type of model, such as a same type of large language model (LLM) (e.g., a Generative Pre-trained Transformer). In some examples, each instance may have the same model parameters but in other examples, one or more model instances may have different model parameters from one or more other instances. In some examples, an instance may have dedicated hardware resources assigned to it, in other examples the models may utilize virtualized computing resources. Each model instance may include its own scheduler component that manages batching and execution of requests and maintains a queue of requests to be processed.

Despite the widespread adoption of generative artificial intelligence (GAI) models and existing optimization techniques, current approaches face significant challenges in efficiently routing requests across multiple model instances. GAI workloads have distinct prefill and decode phases with different compute and memory requirements that should ideally be accounted for when scheduling input queries across different instances. However, existing instance routing algorithms treat these workloads as monolithic jobs without considering these distinct characteristics, leading to sub-optimal routing and increased response latency.

The distinct characteristics arise because GAI models go through separate prompt/prefill and decode phases while serving a request. The prefill phase processes input tokens in parallel, performing self-attention computations at each layer, making it typically compute bound. In contrast, the decode phase generates output tokens sequentially based on the forward pass of the last output token and cached context from previous tokens, making it memory bound. The response generation continues until either an EOS token is produced or the maximum token count is reached.

These different phases have significant implications for processing time. The batch execution time increases linearly with the number of prompt tokens during the compute-intensive prefill phase, while showing much slower growth during the decode phase. This means the total processing time for a request depends on both its prompt token count and decode token count, with the prefill phase having a more dramatic impact on execution time. Similarly, when estimating availability of model instances, the system must consider the remaining iterations and average batch processing time.

Current instance routing techniques like round-robin or load balancing based solely on queue length fail to account for these critical differences in prompt and decode characteristics. By ignoring both the specific token counts of incoming requests and the existing prompt and decode workload distributions at each model instance, these approaches lead to sub-optimal request assignments that significantly increase response latency.

Disclosed in some examples are methods, systems, and machine-readable mediums that solve the problem of sub-optimal request routing and increased latency in generative artificial intelligence (GAI) model instance routing by implementing an intelligent router that makes data-driven and workload-aware scheduling decisions. The solution employs a trained response-length predictor model to estimate output lengths, determines the current state of multiple GAI instances including prompt and decode distributions, and estimates workload mixing impact when combining different types of requests on the same model instance. A machine-learning routing model, implemented using reinforcement learning, then uses this information to either route incoming requests to specific GAI instances or strategically delay routing to optimize overall system performance. This approach reduces queuing at model instances compared to current routing schemes by accounting for variations in input and output characteristics of workloads, achieving improved end-to-end latency through strategic routing decisions that consider the distinct characteristics of GAI workload phases.

By implementing workload-aware routing and strategic delay capabilities, the system may achieve, in some scenarios, over 11% lower end-to-end latency in completing a query compared to existing approaches like round-robin routing. The intelligent router's ability to predict output lengths with 79% accuracy across different types of requests enables better workload distribution and resource utilization. Additionally, the system significantly improves Time-To-First-Token (TTFT) metrics, effectively halving the TTFT for late-arriving requests by making informed routing decisions rather than immediately routing requests to potentially sub-optimal instances. The solution's workload-guided reinforcement learning approach minimizes variance in average Time-Between-Tokens (TBT) and reduces the number of requests queuing at model instances, leading to more consistent and predictable performance. Furthermore, by considering the distinct characteristics of prefill and decode phases and strategically avoiding mixing requests with diverse characteristics on single instances, the system prevents performance degradation that typically occurs when serving concurrent requests with different computational needs.

Current GAI model instance routing systems suffer from technical problems in that they sub-optimally route requests to GAI model instances by treating GAI workloads as monolithic jobs without considering the distinct characteristics of their prefill and decode phases, leading to increased response latency. The technical solution disclosed herein reduces request latency by implementing an intelligent router that makes data-driven and workload-aware scheduling decisions by: (1) using a trained response-length predictor to estimate output lengths, (2) determining the current state of multiple GAI instances including prompt and decode distributions, (3) estimating workload mixing impact when combining different types of requests on the same model instance, and (4) employing a machine-learning routing model that uses this information to either route incoming requests to specific GAI instances or strategically delay routing. This solution reduces queuing at model instances by accounting for workload characteristics and prevents performance degradation from serving requests with diverse computational needs concurrently, achieving over 11% lower end-to-end latency compared to existing approaches. This improves the functionality of the computing system by reducing request latency.

### Overview

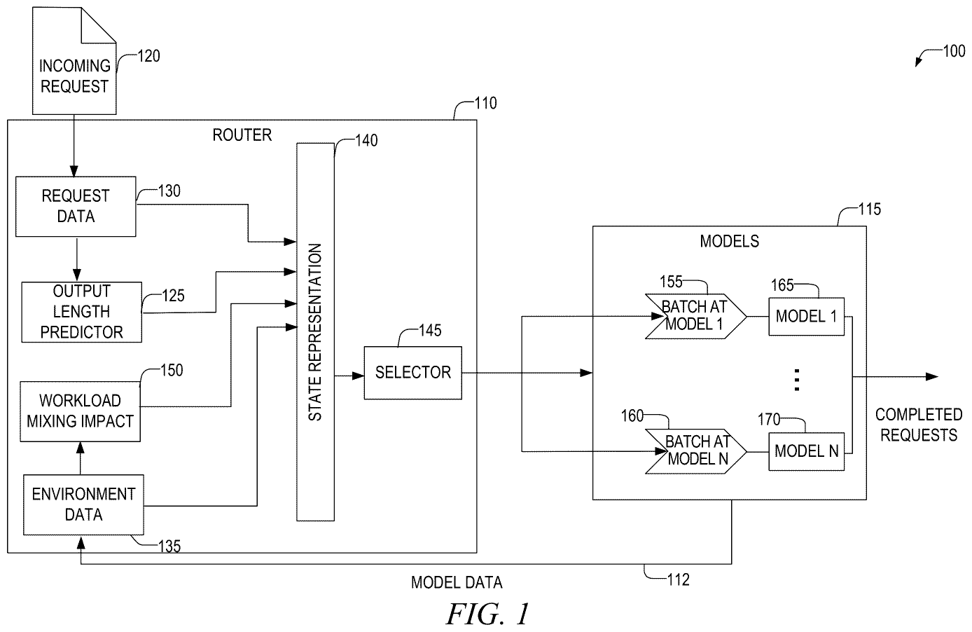

FIG. 1 illustrates a system diagram of a GAI model routing system 100 according to some examples of the present disclosure. When a new request 120 is received from a user, it is processed by the router 110. The router 110 determines which model instance to route the request to. The request 120 first flows to the request data component 130, which analyzes the request and extracts request characteristics including input length and task type. In some examples, task type may be one of: sentiment analysis, entity recognition, in-context Q&A, general Q&A, and translation. The task type may be determined by the request data component 130 using pattern matching, which looks for characteristic prompt patterns like “Please identify if the review is positive or negative?” for sentiment analysis or “Can you identify the entity mentioned?” for entity recognition tasks. The patterns may be prespecified. The request data component processes this information to create a structured representation that can be used by other components of the router.

The request data and incoming request 120 is then passed to the output length predictor component 125, which uses a lightweight machine-learning model, such as a fine-tuned DistillBERT model, to estimate the expected output length in tokens. In some examples, the predictor appends the task type (determined from the request data component 130) as a hint to the prompt to achieve greater accuracy. In some examples, by appending the task hint, a 79% output length prediction accuracy may be achieved. In addition, the expected output may be categorized into buckets based on completion time rather than fixed token ranges. These buckets range from 0-250 tokens for quick responses to over 2048 tokens for longer outputs, with the categorization directly tied to expected processing time. In some examples, buckets with ranges of 0-0.5 seconds, 0.5-0.5×4 seconds, 0.5×4-0.5×8 seconds and so on may be used. In some examples, using unequal bucket sizes helps better distribute the requests among buckets and helps by aligning the bucket ranges with the expected completion time.

Simultaneously, the environment data component 135 gathers current state information from all model instances through the model data 112 feedback channel. This includes the prompt and decode distributions of existing requests and their token counts, available capacity at each instance, and estimated completion times for currently processing requests.

The workload mixing impact component 150 then estimates how the incoming request would affect performance if routed to each potential model instance. In some examples, the workload mixing impact calculation examines how combining different requests on a model instance affects performance by looking at two aspects. First, it may evaluate the prompt phase impact by analyzing how a new request's prompt processing would affect the model instance's performance. This involves looking at how many tokens are in the new request and how many total tokens are already being processed by that instance. The system may use a small adjustment factor to model how adding more tokens affects processing time, and if the calculated impact is too high, it applies an extra penalty to discourage overloading the instance.

For the decode phase impact, the system may utilize the impact of adding another request affects the model's ability to generate output tokens. This considers both how many requests are already running on the instance and the total number of tokens being processed. The system uses an even smaller adjustment factor here since the decode phase typically has less impact on overall performance than the prompt phase.

These two impacts may then be combined into a final mixing penalty score using a weighted average. The weighting allows the system to balance how much importance it places on prompt phase versus decode phase impacts when making routing decisions. The calculation takes into account both the current state of the system and what the state would become after routing the request. When a model instance isn't processing any requests, the system ensures the impact scores stay within reasonable bounds to maintain consistent decision-making.

The state representation component 140 aggregates all this information—the request characteristics, predicted output length, environment state, and mixing impact calculations-into a comprehensive state vector. This vector is structured to maintain manageable dimensionality while capturing all essential information needed for routing decisions, including queue lengths and resource utilization across all model instances. For each model instance, the vector describes how many requests are currently waiting to be processed in the queue. For any new incoming request, it records exactly how many tokens are in the prompt portion, while also noting which category the expected response length falls into based on the output length predictor's assessment.

The vector also includes information about how requests are distributed across all the model instances in two ways. First, it tracks how many requests with different prompt lengths are currently being processed by each model instance. Second, it monitors how many requests with different expected response lengths are being handled by each instance. This distribution information helps understand the current workload patterns across the system. Additionally, the vector keeps track of how much processing capacity is available at each model instance, which is determined by looking at the current batch size and how requests are distributed, as well as tracking when the first request at each instance is expected to complete.

Finally, the selector component 145 processes this state vector through a machine-learning algorithm, such as a double Deep Q-Network (DQN) neural network with multiple layers, to determine the optimal routing action. The selector can either route the request immediately to the most suitable model instance or strategically delay routing if current conditions suggest waiting would be beneficial. This decision is based on a reward function that considers completion time, queue length, and workload mixing impacts. The selector's reinforcement learning model may be trained to optimize these decisions over time, with the influence of heuristic guidance gradually decreasing during training through a guidance discount factor.

If the request is routed to one of the model instances 115, it enters that instance's batch component 155, 160, where it is processed through the distinct prefill and decode phases using a First-Come-First-Served (FCFS) policy. Once the request is released by the batch component, the request is processed by the model 165, 170. Throughout this process, the model instances continue sending performance data back through the model data 112 channel, creating a feedback loop that enables continuous optimization of routing decisions.

Each aspect of the system will be examined in greater detail.

### Output Length Prediction

As noted, the output length predictor component 125 may be a machine-learning model. In some examples, the output length predictor component 125 may be a compact and efficient transformer-based language model, such as a distilled version of BERT (Bidirectional Encoder Representations from Transformers) called DistillBERT. In some examples, the model is optimized using a request dataset where each request is categorized into a bucket based on the number of output tokens in its response. The buckets are used as labels and input prompts as inputs to fine tune the model for predicting the range of output tokens for new requests. In some examples, buckets of equal size are used. In other examples, the bucket rangers are defined based upon the estimated completion time for the request. In some examples, buckets with ranges of 0-0.5 seconds, 0.5-0.5×4 seconds, 0.5×4-0.5×8 seconds and so on. In some examples, using unequal bucket sizes helps better distribute the requests among buckets and helps by aligning the bucket ranges with the expected completion time.

### Workload Impact Estimation

Next, the router estimates the workload impact. Let there be n requests within a model instance m, and

$${p}_{j}^{m} and {d}_{j}^{m}$$

indicate the number of prompt and decode tokens processed by the j-th existing request at model m. As the impact on the prompt phase is directly proportional to the number of prompt tokens in the request and the total number of tokens already running in the decode phase, we can model the impact on the prompt phase (the time to process

$${p}_{i} , {T}_{{p}_{i}}^{m} )$$

of an incoming request with pᵢ tokens when added to the model instances with n requests and corresponding penalty as:

$$\begin{matrix}{T}_{{p}_{i}}^{m} = {grad}_{1} * ( ( {p}_{i}^{2} + {\sum }_{j = 1}^{n} ( {p}_{j}^{m} + {d}_{j}^{m} ) ) ) \\ {r}_{{p}_{i}}^{m} = \{ \begin{matrix}1 if {T}_{{p}_{i}}^{m} \leq ∈ \\ 1 - \frac{{T}_{{p}_{i}}^{m}}{∈} otherwise\end{matrix}\end{matrix} \qquad ( equation 1 )$$

In some examples, a penalty is introduced if a latency impact exceeds E.

Similarly, the impact on existing requests beyond the prompt phase is directly proportional to the total number of requests in the model. We can model the penalty due to the impact of an incoming request with pᵢ prompt tokens and dᵢ decode tokens on the decode phase of already existing n requests as:

$${r}_{d}^{m} = - {grad}_{2} * {\sum }_{j = 1}^{n} ( {p}_{j}^{m} + {d}_{j}^{m} ) + {p}_{i} + {d}_{i} \qquad ( equation 2 )$$

In some examples grad₁=3.2×10⁻⁴ and grad₂=3.3×10⁻⁵. Given those values, the values of

$${r}_{d}^{m} and {T}_{{p}_{i}}^{m}$$

are expected to be in the ranges of [−1,1] and [−1,0] respectively when there are no requests waiting at the model instance. Equations (1) and (2) may be combined to get the final penalty of mixing requests:

$${r}_{mixi ng} ( {s}_{t} , {s}_{t + 1} ) = α {r}_{{p}_{i}}^{n} + ( 1 - α ) {r}_{d}^{m}$$

where m is the action taken for the state transition Sₜ→Sₜ₊₁ The parameter α ∈ (0,1) balances priority over the prompt and decode phases.

### RL Based Router

In some examples, the problem of routing incoming requests to the m model instances may be modeled as discrete-time Markov Decision Process (MDP) which may be handled by a reinforcement learning-based model. The discounted MDP is denoted as a tuple [symbol] (S, A, P, r, γ), where S is the state space, A is the action space, P(s′|s,a) is the transition dynamics, r(s,a) is the reward function, and γ∈[0,1) is the discount factor. The goal is to find the policy π(s|α), a distribution of actions over states, which maximizes the discounted return

$${G}_{t} = {\sum }_{k = 0}^{∞} {γ}^{k} {r}_{t} + k + 1$$

in expectation. An arrival rate of λ for the requests and the ideal estimated time to complete request i as \hat{T}ᵢ. Let Oⱼₜ denote the total number of output tokens produced until time t by request j, and \hat{d}ⱼₜ denote the estimated decode tokens for the j-th request. Therefore, the fraction of request j completed at time t may be denoted as

$${f}_{jt} := \frac{{o}_{jt}}{{\hat{d}}_{jt}} .$$

A state transition is assumed at every Δt, where Δt is the average time to generate a decode token.

### State Space

At time t, the state of the system, which comprises m model instances and requests waiting in the queue, can be captured by the following: 1.) The number of requests in the queue at time t, denoted by W_{q}_{ₜ}; 2.) The exact number of prompt tokens, denoted by pₜ ∈ [symbol] , and the estimated bucket for decode tokens, denoted by dₜ ∈{0, . . . , n_{d}}, corresponding to the next request in the queue. Here, the estimated bucket varies from zero to n_{d}; 3.) Matrices, Pₜ ∈ [symbol] ^{mn}^{ₚ} and Dₜ [symbol] ^{mn}^{_{d}}, capturing the prompt and decode distribution of requests at the model instances. The prompt (decode) distribution may be represented by nₚ (n_{d}) buckets. (Pₜ)_{i,j}((Dₜ)_{i,j}) denotes the number of requests in prompt (decode) phase at the i-th model instance that are present in the j-th bucket—i.e., have j prompt (decode) tokens. The prompt and decode distributions may be represented across the model instances as a matrix, which maintains the finite dimensionality of the state space. 4.) The capacity available at the model instances at time t is denoted by Cₜ∈ [symbol] ^{m}, as a function g(batch size, Pₜ, Dₜ); and 5) the estimated completion time for the earliest request in the model j, denoted by \hat{T}_{c}_{ₜ}.

### Action Space

At any given point in time, the agent must decide whether to schedule incoming request i to any of the m model instances or choose to take no action (e.g., to wait). Therefore α∈{0, . . . , m}. Here, index m refers to no action being taken by the router.

### Reward Design

In some examples, the following elements may be included in the reward formulation: a.) a negative penalty for requests in the queue, decreasing as requests are processed, to account for the autoregressive nature of requests, b.) a positive reward for each completed request, and c) a workload impact estimator-based penalty, which encodes the adverse effect of routing specific requests to a model instance with existing requests, and prevents requests from being queued at each model instance due to a lack of memory. Adding the workload impact estimator-based penalty directly to the reward function may introduce bias. Therefore, in some examples, the prior knowledge may be augmented using a heuristic-guided formulation, and the reward at time t is given by:

$${r}_{t} = - {\sum }_{j ∈ 𝒥} ( \frac{1}{{\hat{T}}_{j}} - {f}_{jt} ) ) + {\sum }_{j = 1}^{m} {\sum }_{i} {r}_{w} * {w}_{{mi}_{t}} - ( γ - \tilde{γ} k ) h ( {s}_{t} , {s}_{t} + 1 ) \qquad ( equation 3 )$$

$$Where h ( {s}_{t} , {s}_{t} + 1 ) = {r}_{mixing} ( {s}_{t} , {s}_{t + 1} ) - {max}_{l = 1 , … . , m} ( {r}_{mixing} ( {s}_{t} , {s}_{t + 1}^{l} ) ) \qquad ( equation 4 )$$

Here [symbol] includes the set of scheduled and unscheduled requests, and Wₘᵢ_{ₜ}∈{0,1} indicates whether the ith at the mth model completed at time t. r_{w}∈ [symbol] ⁺ is the positive regard for completing a request. The function h: S×S→ [symbol] represents the difference in penalty due to assigning the incoming request to a model other than the one for which the impact is minimum (a function of equations 1 and 2). The term “guidance discount” is given by \tilde{γ}k=λₖγ, where the subscript k denotes the k-th episode. Here, λₖ∈[0,1] is the mixing coefficient and settles to zero with an increase in episodes. The discount factor in the MDP is set to [symbol] during training. The function h( ) returns zero when the request is assigned to the model with the least work load mixing impact. Intuitively, the formulation introduces horizon-based regularization, and its strength diminishes as the mixing coefficient increases, which modifies the original MDP, [symbol] =(S, A, P, r, γ), to [symbol] =(S, A, P, \tilde{r}, \tilde{γ}). Over the course of training, the agent interacts with the environment, and the effects of the heuristic in the MDP decrease, and the agent eventually optimizes for the original MDP.

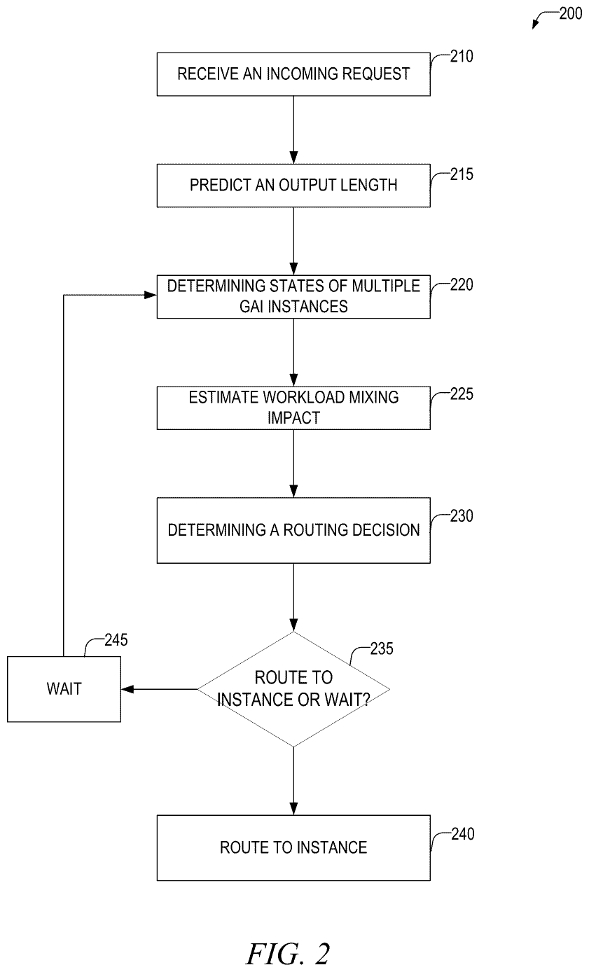

FIG. 2 shows a flowchart of a method 200 of intelligently routing a request to one of a plurality of GAI instances according to some examples of the present disclosure. At operation 210, the method begins with receiving an incoming request. The request may be received over a network, such as from a user's computing device. At operation 215, the system predicts an output length. In some examples, the output length may be predicted by a machine-learning model to estimate the expected output length in tokens for the incoming request. The prediction helps in understanding the computational requirements of the request.

At operation 220, the method involves determining states of multiple GAI instances. This step gathers current state information from all available GAI instances, including their prompt and decode distributions, token counts, available capacity, and estimated completion times for currently processing requests.

At operation 225, the method estimates workload mixing impact. This step evaluates how the incoming request would affect the performance of each potential GAI instance by analyzing the impact of combining different requests on a model instance. The system considers both the prompt phase and decode phase impacts, applying penalties if the calculated impact exceeds certain thresholds.

At operation 230, the method involves determining a routing decision using a routing model. In some examples, this routing model is a machine-learning algorithm, such as a reinforcement learning-based model which may take as input the current state of the instances, the estimated workload mixing impact, and the like. In some examples, the output of the model is an instance number, or an indication that the routing should be delayed. In some examples, the indication that the routing should be delayed is a number that is one greater than the number of GAI model instances.

At operation 235, the method evaluates the routing decision. If the routing decision is to route the request to one of the GAI instances, the method proceeds to operation 240, where the request is routed to the instance determined by the routing model.

If the routing decision is to wait, the method enters operation 245, a wait state. This step involves delaying the routing decision until conditions improve, ensuring that the request is routed optimally. Once the wait phase is over at 245, the evaluation is repeated at operations 220-235.

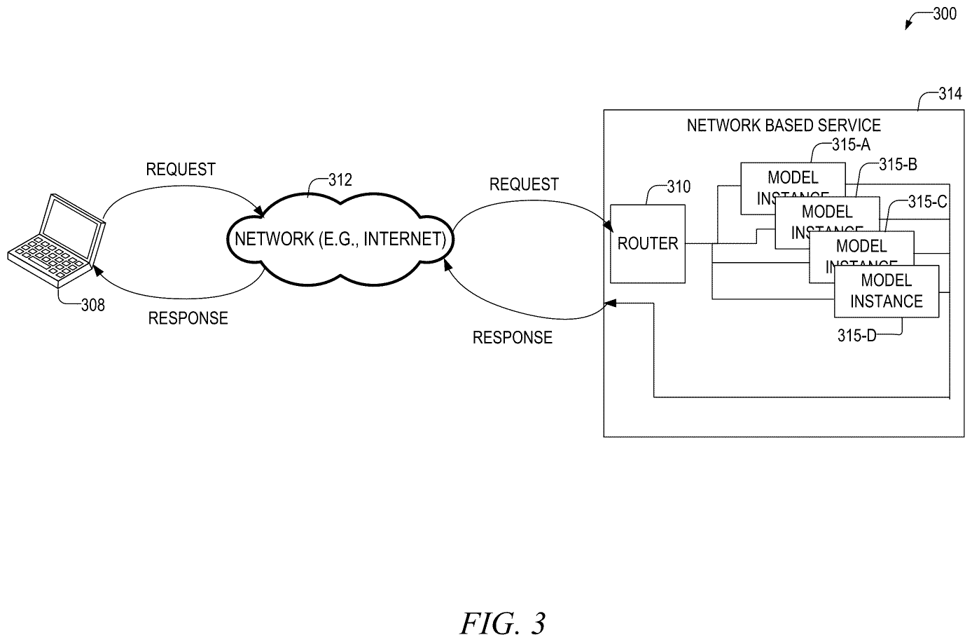

FIG. 3 shows a system 300 of a network-based GAI inference service 314 according to some examples of the present disclosure. The system 300 includes a user computing device 308, a network 312, a router 310, and multiple model instances 315-A, 315-B, 315-C, and 315-D within the network-based service 314.

The user computing device 308 initiates a request that is transmitted over the network 312. The network 312, which can be the Internet or some other computer network, facilitates the communication of the request to the network-based service 314. The request is first handled by the router 310. The router 310, receives the request and is responsible for routing the request to one of the model instances 315-A, 315-B, 315-C, or 315-D. In some examples, router 310 may be an example of router 110 and may implement the intelligent routing described herein.

Each model instance 315-A, 315-B, 315-C, and 315-D within the network-based service 314 is capable of processing the request. The router 310 determines the most suitable model instance to handle the request based on various factors such as current load, request characteristics, and predicted output length. Once the router 310 routes the request to a selected model instance, the model instance processes the request and generates a response.

The response is then sent back through the router 310, which transmits the response over the network 312 to the user computing device 308. The user computing device 308 receives the response, completing the request-response cycle.

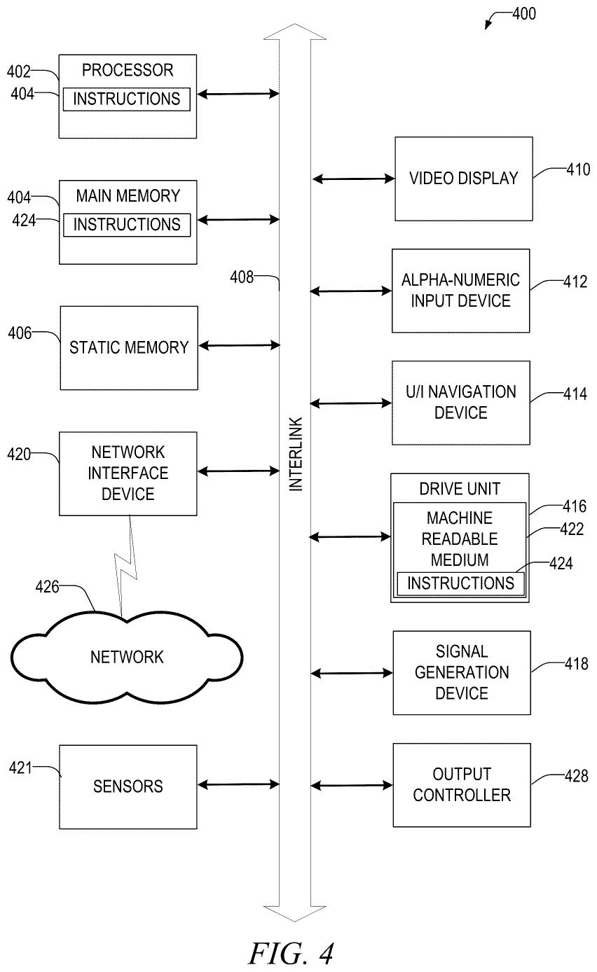

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The machine 400 may implement any of the components of FIGS. 1 and 3 and the method of FIG. 2.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### Other Notes and Examples

Example 1 is a method for routing a request amongst a plurality of generative artificial intelligence (GAI) model instances to decrease request latency, the method comprising: receiving an incoming request; predicting an output length for the incoming request using a trained response-length predictor model, the trained response length predictor predicting a length of a response of an instance of the GAI model to the incoming request, the length of the response a number of tokens in an output of the GAI model given the incoming request; determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance; estimating a workload mixing impact of routing the incoming request to each of the multiple GAI instances, the workload mixing impact representing an estimated impact on latency when adding the incoming request to each of the multiple GAI instances; determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and routing the incoming request to one of the multiple GAI instances for completion or delaying routing to a later time based upon the routing decision.

In Example 2, the subject matter of Example 1 includes, wherein the trained response-length predictor model is a transformer-based language model trained on a dataset comprising one or more of: sentiment analysis requests, entity recognition requests, in-context question and answer requests, general question and answer requests, or translation requests.

In Example 3, the subject matter of Examples 1-2 includes, wherein the GAI model is a large language model (LLM).

In Example 4, the subject matter of Examples 1-3 includes, wherein the machine-learning routing model comprises a neural network trained on predicted output lengths of a dataset comprising one or more of: sentiment analysis requests, entity recognition requests, in-context question and answer requests, general question and answer requests, or translation requests.

In Example 5, the subject matter of Examples 1-4 includes, wherein the method further comprises training the machine-learning routing model, the training comprising: using a state representation that includes the predicted output length, the state of the multiple GAI instances, and the estimated workload mixing impact; utilizing a reward function and a penalty term derived from the estimated workload mixing impact, wherein the reward function: penalizes incomplete requests, rewards completed requests, incorporates a penalty based on a difference between the GAI instance where the request is routed and an optimal instance for minimizing workload mixing impact, and includes a time-varying factor that gradually reduces an influence of heuristic guidance over a course of training; utilizing a guidance discount factor that decreases over training episodes; and iteratively updating parameters of the machine-learning routing model based on the reward function and the guidance discount factor to optimize routing decisions.

In Example 6, the subject matter of Examples 1-5 includes, wherein estimating the workload mixing impact comprises: calculating a prompt phase impact for the incoming request on each GAI instance, wherein the prompt phase impact is determined based on a number of prompt tokens in the incoming request and a total number of tokens being processed by existing requests in the GAI instance; calculating a decode phase impact for the incoming request on each GAI instance, wherein the decode phase impact is determined based on the number of prompt and decode tokens in the incoming request and the total number of tokens being processed by existing requests in the GAI instance; combining the prompt phase impact and decode phase impact using a weighted sum; and determining the workload mixing impact based on a combined impact for each GAI instance, where the impact represents ab estimated effect on performance when adding the incoming request to an existing workload of the GAI instance.

In Example 7, the subject matter of Examples 1-6 includes, wherein the output of the machine-learning routing model is either an index of one of the plurality of GAI model instances or a number indicating that the request should be delayed.

In Example 8, the subject matter of Examples 1-7 includes, wherein the routing of the incoming request is delayed; and wherein the delay involves periodically re-evaluating the request to determine if it should be routed to one of the plurality of GAI instances.

Example 9 is a computing device for routing a request amongst a plurality of generative artificial intelligence (GAI) model instances to decrease request latency, the computing device comprising: a hardware processor; a memory, the memory storing instructions, which when executed by the hardware processor cause the computing device to perform operations comprising: receiving an incoming request; predicting an output length for the incoming request using a trained response-length predictor model, the trained response length predictor predicting a length of a response of an instance of the GAI model to the incoming request, the length of the response a number of tokens in an output of the GAI model given the incoming request; determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance; estimating a workload mixing impact of routing the incoming request to each of the multiple GAI instances, the workload mixing impact representing an estimated impact on latency when adding the incoming request to each of the multiple GAI instances; determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and routing the incoming request to one of the multiple GAI instances for completion or delaying routing to a later time based upon the routing decision.

In Example 10, the subject matter of Example 9 includes, wherein the trained response-length predictor model is a transformer-based language model trained on a dataset comprising one or more of: sentiment analysis requests, entity recognition requests, in-context question and answer requests, general question and answer requests, or translation requests.

In Example 11, the subject matter of Examples 9-10 includes, wherein the GAI model is a large language model (LLM).

In Example 12, the subject matter of Examples 9-11 includes, wherein the machine-learning routing model comprises a neural network trained on predicted output lengths of a dataset comprising one or more of: sentiment analysis requests, entity recognition requests, in-context question and answer requests, general question and answer requests, or translation requests.

In Example 13, the subject matter of Examples 9-12 includes, wherein the operations further comprise training the machine-learning routing model, the training comprising: using a state representation that includes the predicted output length, the state of the multiple GAI instances, and the estimated workload mixing impact; utilizing a reward function and a penalty term derived from the estimated workload mixing impact, wherein the reward function: penalizes incomplete requests, rewards completed requests, incorporates a penalty based on a difference between the GAI instance where the request is routed and an optimal instance for minimizing workload mixing impact, and includes a time-varying factor that gradually reduces an influence of heuristic guidance over a course of training; utilizing a guidance discount factor that decreases over training episodes; and iteratively updating parameters of the machine-learning routing model based on the reward function and the guidance discount factor to optimize routing decisions.

In Example 14, the subject matter of Examples 9-13 includes, wherein the operation of estimating the workload mixing impact comprises: calculating a prompt phase impact for the incoming request on each GAI instance, wherein the prompt phase impact is determined based on a number of prompt tokens in the incoming request and a total number of tokens being processed by existing requests in the GAI instance; calculating a decode phase impact for the incoming request on each GAI instance, wherein the decode phase impact is determined based on the number of prompt and decode tokens in the incoming request and the total number of tokens being processed by existing requests in the GAI instance; combining the prompt phase impact and decode phase impact using a weighted sum; and determining the workload mixing impact based on a combined impact for each GAI instance, where the impact represents an estimated effect on performance when adding the incoming request to an existing workload of the GAI instance.

In Example 15, the subject matter of Examples 9-14 includes, wherein the output of the machine-learning routing model is either an index of one of the plurality of GAI model instances or a number indicating that the request should be delayed.

In Example 16, the subject matter of Examples 9-15 includes, wherein the routing of the incoming request is delayed; and wherein the delay involves periodically re-evaluating the request to determine if it should be routed to one of the plurality of GAI instances.

Example 17 is a machine-readable medium, storing instructions for routing a request amongst a plurality of generative artificial intelligence (GAI) model instances to decrease request latency, the instructions, which when executed, cause the machine to perform operations comprising: receiving an incoming request; predicting an output length for the incoming request using a trained response-length predictor model, the trained response length predictor predicting a length of a response of an instance of the GAI model to the incoming request, the length of the response a number of tokens in an output of the GAI model given the incoming request; determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance; estimating a workload mixing impact of routing the incoming request to each of the multiple GAI instances, the workload mixing impact representing an estimated impact on latency when adding the incoming request to each of the multiple GAI instances; determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and routing the incoming request to one of the multiple GAI instances for completion or delaying routing to a later time based upon the routing decision.

In Example 18, the subject matter of Example 17 includes, wherein the trained response-length predictor model is a transformer-based language model trained on a dataset comprising one or more of: sentiment analysis requests, entity recognition requests, in-context question and answer requests, general question and answer requests, or translation requests.

In Example 19, the subject matter of Examples 17-18 includes, wherein the GAI model is a large language model (LLM).

In Example 20, the subject matter of Examples 17-19 includes, wherein the machine-learning routing model comprises a neural network trained on predicted output lengths of a dataset comprising one or more of: sentiment analysis requests, entity recognition requests, in-context question and answer requests, general question and answer requests, or translation requests.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for routing a request amongst a plurality of generative artificial intelligence (GAI) model instances to decrease request latency, the method comprising:
receiving an incoming request;
predicting an output length for the incoming request using a trained response-length predictor model, the trained response length predictor predicting a length of a response of an instance of the GAI model to the incoming request, the length of the response a number of tokens in an output of the GAI model given the incoming request;
determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance;
estimating a workload mixing impact of routing the incoming request to each of the multiple GAI instances, the workload mixing impact representing an estimated impact on latency when adding the incoming request to each of the multiple GAI instances;
determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and
routing the incoming request to one of the multiple GAI instances for completion or delaying routing to a later time based upon the routing decision.

2. The method of claim 1, wherein the trained response-length predictor model is a transformer-based language model trained on a dataset comprising one or more of: sentiment analysis requests, entity recognition requests, in-context question and answer requests, general question and answer requests, or translation requests.

3. The method of claim 1, wherein the GAI model is a large language model (LLM).

4. The method of claim 1, wherein the machine-learning routing model comprises a neural network trained on predicted output lengths of a dataset comprising one or more of: sentiment analysis requests, entity recognition requests, in-context question and answer requests, general question and answer requests, or translation requests.

5. The method of claim 1, wherein the method further comprises training the machine-learning routing model, the training comprising:
using a state representation that includes the predicted output length, the state of the multiple GAI instances, and the estimated workload mixing impact;
utilizing a reward function and a penalty term derived from the estimated workload mixing impact, wherein the reward function: penalizes incomplete requests, rewards completed requests, incorporates a penalty based on a difference between the GAI instance where the request is routed and an optimal instance for minimizing workload mixing impact, and includes a time-varying factor that gradually reduces an influence of heuristic guidance over a course of training;
utilizing a guidance discount factor that decreases over training episodes; and
iteratively updating parameters of the machine-learning routing model based on the reward function and the guidance discount factor to optimize routing decisions.

6. The method of claim 1, wherein estimating the workload mixing impact comprises:
calculating a prompt phase impact for the incoming request on each GAI instance, wherein the prompt phase impact is determined based on a number of prompt tokens in the incoming request and a total number of tokens being processed by existing requests in the GAI instance;
calculating a decode phase impact for the incoming request on each GAI instance, wherein the decode phase impact is determined based on the number of prompt and decode tokens in the incoming request and the total number of tokens being processed by existing requests in the GAI instance;
combining the prompt phase impact and decode phase impact using a weighted sum; and
determining the workload mixing impact based on a combined impact for each GAI instance, where the impact represents ab estimated effect on performance when adding the incoming request to an existing workload of the GAI instance.

7. The method of claim 1, wherein the output of the machine-learning routing model is either an index of one of the plurality of GAI model instances or a number indicating that the request should be delayed.

8. The method of claim 1, wherein the routing of the incoming request is delayed; and wherein the delay involves periodically re-evaluating the request to determine if it should be routed to one of the plurality of GAI instances.

9. A computing device for routing a request amongst a plurality of generative artificial intelligence (GAI) model instances to decrease request latency, the computing device comprising:
a hardware processor;
a memory, the memory storing instructions, which when executed by the hardware processor cause the computing device to perform operations comprising:
receiving an incoming request;
predicting an output length for the incoming request using a trained response-length predictor model, the trained response length predictor predicting a length of a response of an instance of the GAI model to the incoming request, the length of the response a number of tokens in an output of the GAI model given the incoming request;
determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance;
estimating a workload mixing impact of routing the incoming request to each of the multiple GAI instances, the workload mixing impact representing an estimated impact on latency when adding the incoming request to each of the multiple GAI instances;
determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and
routing the incoming request to one of the multiple GAI instances for completion or delaying routing to a later time based upon the routing decision.

10. The computing device of claim 9, wherein the trained response-length predictor model is a transformer-based language model trained on a dataset comprising one or more of: sentiment analysis requests, entity recognition requests, in-context question and answer requests, general question and answer requests, or translation requests.

11. The computing device of claim 9, wherein the GAI model is a large language model (LLM).

12. The computing device of claim 9, wherein the machine-learning routing model comprises a neural network trained on predicted output lengths of a dataset comprising one or more of:
sentiment analysis requests, entity recognition requests, in-context question and answer requests, general question and answer requests, or translation requests.

13. The computing device of claim 9, wherein the operations further comprise training the machine-learning routing model, the training comprising:
using a state representation that includes the predicted output length, the state of the multiple GAI instances, and the estimated workload mixing impact;
utilizing a reward function and a penalty term derived from the estimated workload mixing impact, wherein the reward function: penalizes incomplete requests, rewards completed requests, incorporates a penalty based on a difference between the GAI instance where the request is routed and an optimal instance for minimizing workload mixing impact, and includes a time-varying factor that gradually reduces an influence of heuristic guidance over a course of training;
utilizing a guidance discount factor that decreases over training episodes; and
iteratively updating parameters of the machine-learning routing model based on the reward function and the guidance discount factor to optimize routing decisions.

14. The computing device of claim 9, wherein the operation of estimating the workload mixing impact comprises:
calculating a prompt phase impact for the incoming request on each GAI instance, wherein the prompt phase impact is determined based on a number of prompt tokens in the incoming request and a total number of tokens being processed by existing requests in the GAI instance;
calculating a decode phase impact for the incoming request on each GAI instance, wherein the decode phase impact is determined based on the number of prompt and decode tokens in the incoming request and the total number of tokens being processed by existing requests in the GAI instance;
combining the prompt phase impact and decode phase impact using a weighted sum; and
determining the workload mixing impact based on a combined impact for each GAI instance, where the impact represents an estimated effect on performance when adding the incoming request to an existing workload of the GAI instance.

15. The computing device of claim 9, wherein the output of the machine-learning routing model is either an index of one of the plurality of GAI model instances or a number indicating that the request should be delayed.

16. The computing device of claim 9, wherein the routing of the incoming request is delayed; and wherein the delay involves periodically re-evaluating the request to determine if it should be routed to one of the plurality of GAI instances.

17. A machine-readable medium, storing instructions for routing a request amongst a plurality of generative artificial intelligence (GAI) model instances to decrease request latency, the instructions, which when executed, cause the machine to perform operations comprising:
receiving an incoming request;
predicting an output length for the incoming request using a trained response-length predictor model, the trained response length predictor predicting a length of a response of an instance of the GAI model to the incoming request, the length of the response a number of tokens in an output of the GAI model given the incoming request;
determining a state of multiple GAI instances, including prompt and decode distributions of requests at each GAI instance, the prompt distribution representing input lengths for requests currently being processed by a particular GAI instance and the decode distribution representing expected output lengths for requests being processed by the particular GAI instance;
estimating a workload mixing impact of routing the incoming request to each of the multiple GAI instances, the workload mixing impact representing an estimated impact on latency when adding the incoming request to each of the multiple GAI instances;
determining a routing decision using a machine-learning routing model and based upon the predicted output length of the incoming request, the state of each of the multiple GAI instances, and the estimated workload mixing impact, the routing decision indicating either one of the plurality of GAI instances for handling the request or a decision to delay routing; and
routing the incoming request to one of the multiple GAI instances for completion or delaying routing to a later time based upon the routing decision.

18. The machine-readable medium of claim 17, wherein the trained response-length predictor model is a transformer-based language model trained on a dataset comprising one or more of: sentiment analysis requests, entity recognition requests, in-context question and answer requests, general question and answer requests, or translation requests.

19. The machine-readable medium of claim 17, wherein the GAI model is a large language model (LLM).

20. The machine-readable medium of claim 17, wherein the machine-learning routing model comprises a neural network trained on predicted output lengths of a dataset comprising one or more of: sentiment analysis requests, entity recognition requests, in-context question and answer requests, general question and answer requests, or translation requests.
